(19) United States
(12) Patent Application Publication
(10) Pub. No.: US 2011/0133113 A1
(43) Pub. Date: Jun. 9, 2011

(54) "MALONE" ENGINE WITH CARBON DIOXIDE IN LIQUID SOLUTION

(76) Inventors: Marieta Pancheva, Sofia (BG); Viadimir Panchev, Sofia (BG); Adelina Suvandjieva, Sofia (BG)

(21) Appl. No.: 13/057,725

(22) PCT Filed: Jul. 28, 2009
(86) PCT No.: PCT/BG2009/000010

§ 371 Date: Feb. 4, 2011

(30) Foreign Application Priority Data
Aug. 12, 2008 (BG) 110196

(51) Int. Cl. C09K 5/04

(52) U.S. Cl. 252/67

(57) ABSTRACT

The invention refers to applying carbon dioxide (CO2) solution in liquid, as working fluid in the “Malone” engines, by all possible pressures in the cool reservoir. These solutions have multiply greater coefficient of thermal expansion, by which will be avoided all defects of the till know existing engines. As a solvent can be used water and all kinds of other liquids, by which would be obtained an optimal combination between the different indicators. The invention is based on the discovery we made that the blood capillaries of all warm blooded (endothermic) animals represent the working part of “Stirling-Malone” engines with free pistons, in which the working fluid is the containing carbon dioxide blood plasma, the pistons represent the obtaining parachute-form in the capillaries red blood cells, the surrounding tissue is the external heat source, the heart is the external pump (the displacer), the skin veins and the lungs are the cool reservoir (the temperature sink), and all other veins and arteries are heat-transporting tubes and heat exchangers (regenerators).

### BACKGROUND

The “Malone” engines represent engines with external combustion, using the regenerative cycle of Stirling (in which the working fluid is gas), but applied by John Malone for work with liquids. A defect of all “Malone” engines is that the liquids have a very small thermal coefficient of expansion and very high specific heat. This necessitates that they work by great temperature difference between the warm and the cool reservoir and by great pressure difference, which makes them with great weight on unit power, and complicates the sealing of the moving parts.

### DESCRIPTION

The invention consists in applying carbon dioxide (CO₂) solution in liquid, as working fluid in the “Malone” engines, the solution being saturated with this gas in the cool reservoir, by all possible pressures, depending on the desired power and the engine implementation. These solutions have many times greater coefficient of thermal expansion, by which will be avoided all defects of the till know existing engines. As a solvent can be used water and all kinds of other liquids, by which would be obtained an optimal combination between the different indicators. The invention is based on the great solubility carbon dioxide has in liquids, and especially in water, by relatively low pressure, compared with the other gases. Since, by elevating the temperature of the liquid, the solubility of CO₂ decreases, the solution expands, and the pressure in the vessel, in which it is enclosed, increases. The diapason of change of the temperature between the cool and the warm reservoir is not limited.

The invention is based on the discovery we made that the blood capillaries of all warm blooded (endothermic) animals represent the working part of “Stirling-Malone” engines with free pistons, in which the working fluid is the containing carbon dioxide blood plasma, the pistons represent the obtaining parachute-form in the capillaries red blood cells, the surrounding tissue is the external heat source, the heart is the external pump (the displacer), the skin veins and the lungs are the cool reservoir (the temperature sink), and all other veins and arteries are heat-transporting tubes and heat exchangers (regenerators).

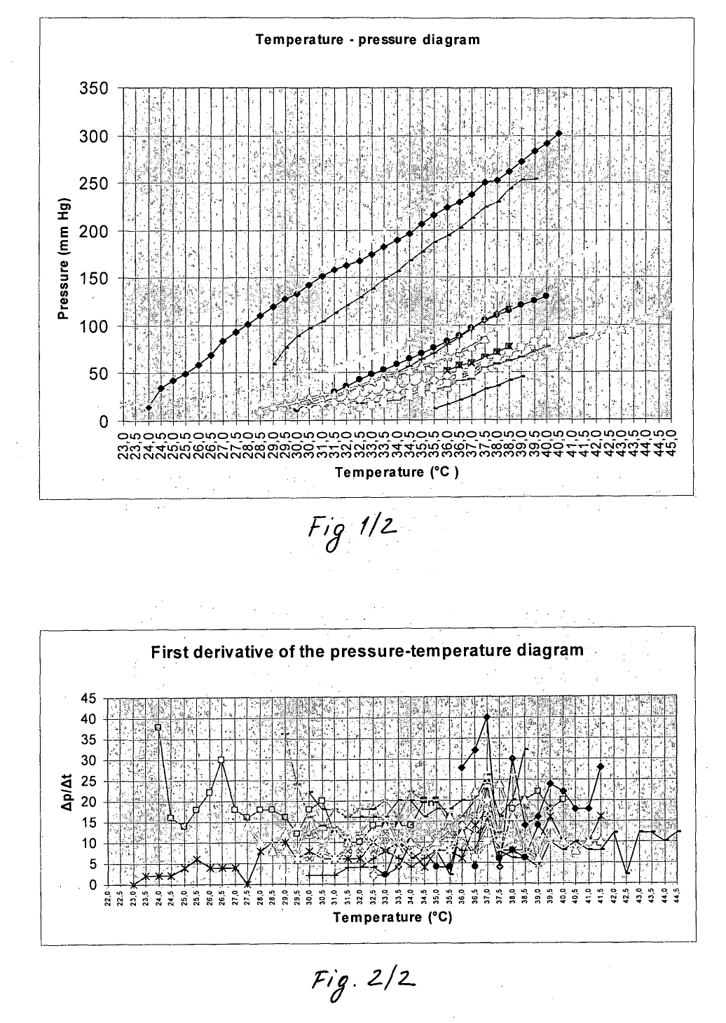

On FIG. 1 are given the curves of the pressure-temperature relationship of water solutions (saline, with 1% NaCl) with different CO₂ saturation. From the diagrams is to be seen that for the correspondent diapason of temperature change, each curve has several bounds, in which its slope changes, but on 37° C. all curves increase their slope. This is especially to be seen on the graphs, given on FIG. 2, where are presented the first derivatives of the graphs from FIG. 1. From them is to be seen that all curves have a maximum on 37° C., which explains the Human's rest body core temperature, and that of the other warm-blooded animals, which have a rest body core temperature with different deviation from this value, depending on the velocity, with which the heat dissipates from their body surface.

1. Composition comprising a water solution of carbon dioxide for use as a working fluid in the “Malone” engines;

2. Composition for use according to claim 1, wherein the composition represents saturated solution of carbon dioxide by all possible pressures in the cool reservoir;

3. Composition for use according to claim 1, wherein the diapason of the temperature change between the cool and the warm reservoir is not limited;

4. Composition comprising a liquid solution of carbon dioxide for use as a working fluid in the “Malone” engines;

5. Composition for use according to claim 4, wherein the solution of carbon dioxide in liquid represents saturated solution of carbon dioxide by all possible pressures in the cool reservoir;

6. Composition for use according to claim 4, wherein as solvent of carbon dioxide are used all possible liquids, by which could be obtained optimal for the respective application combination of the different indicators;

7. Composition for use according to claim 4, wherein the diapason of the temperature change between the cool and the warm reservoir is unlimited;
